(19) United States
(12) Patent Application Publication
(10) Pub. No.: US 2009/0204900 A1
(43) Pub. Date: Aug. 13, 2009

(54) Method And System For Navigation Of Web Sites And Applications

(75) Inventors: David F. Champion, Durham, NC (US); David T. Windell, Raleigh, NC (US)

Correspondence Address: HARRINGTON & SMITH, PC, 4 RESEARCH DRIVE, Suite 202, SHELTON, CT, 06484-6212, US

(73) Assignee: International Business Machines Corporation

(21) Appl. No.: 12/030,473

(22) Filed: Feb. 13, 2008

(51) Int. Cl. G06F 3/00

(52) U.S. Cl. 715/738

(57) ABSTRACT

A method and system to aid in the navigation of a website or computer program having a plurality of resources by displaying a single navigation window having a visual display of all of the resources of the website or program and their hierarchal structure in which at least some of the resources are linked and can be directly accessed from within the window. The window also shows a history of the resources accessed and the paths taken to obtain access.

### FIELD OF THE INVENTION

The present invention is directed to a method and system to aid in the navigation of a website or computer application program by using a window that presents a visual display of all of the resources of the website or application and their overall structure with the resources being linked and individually accessible from within the window.

### BACKGROUND OF THE INVENTION

An Internet website is a collection of web pages, images, videos or other digital resources that is hosted on a computer system known as a web server, also called an HTTP server. Internet websites are written in, or dynamically converted to, HTML (Hyper Text Markup Language). The web server, which usually also refers to the software that runs on these systems, retrieves and delivers the web pages in response to requests from users of the website. Users access a website using a software program called a web browser, also known as an HTTP client. The pages of a website can be viewed or otherwise accessed by a variety of computer-based Intranet and Internet-enabled devices, including desktop computers, workstations, laptop computers, PDAs and suitably configured cell phones. These devices communicate with the web server via conventional resources such as hard wired lines, cable, satellite and wireless transmission.

A website usually is accessed by a user typing the URL address of the website home page in the address bar of his browser. The URL of another page of the site also can be addressed if desired and the discussion below, while directed to the home page, also applies to these other pages. The home page downloaded from the web server and displayed by the user's browser contains links (hyperlinks or URLs) to other pages in the website. The website also downloads to the browser with the homepage, or other page, an applet that controls and manages functions for navigating the website pages. Such applets are often written in JAVA language of Sun Microsystems.

The multiple pages of a website are usually accessed from a common root URL, called the homepage, and all of the pages usually reside on the same physical web server. The user navigates his way through the various pages of the website to access the one or more pages that he really desires to view. The navigation is accomplished by positioning a mouse pointer over a link and depressing the mouse button. This accesses the page from the web server and it is displayed by the browser. The website pages also are often divided into groups related to a common topic or common subject matter, such as About Us, Investor Information, Products, etc. Each group is accessed from a “hot spot” on the browser home page display that is activated when the mouse pointer is positioned over it. Activating a hot spot calls up an embedded pop up menu of the individual pages associated with the group of the activated hot spot. The URLs of all of the website groups can be organized into hierarchies having hyperlinks between the pages of any one group and the pages of the other groups. The hierarchies and their inter-relationships control how the user perceives the overall website structure and how the traffic flows between the different parts of the site.

Computer application programs are often organized in a manner similar to a website. That is, many computer programs such as data center management programs and email management programs are designed in a web-like fashion or layout. This is true even though these application programs may not be hosted on a web server and are only accessed at a single management point. The design is based on program sections that would correspond to website groups. For example, there can be a master menu page and various program sections such as Applications, Network Settings and Security. Each of these sections has one or more subsections, corresponding to website pages, that contain information and/or operating controls to one or functions of the section. For example, the Security section can have sub-sections related to the user profile, security level of his computer, etc. Also, there can be imbedded hyperlinks within the groups and pages an off-line computer application program.

It is a common and increasing trend that users of even the simplest websites and software applications can get “lost” in the structure of the interface. As websites and applications become more complex, this tendency to be unable to backtrack, find new pages, find pages previously accessed and locate discrepancies and fixes becomes more of a challenge. In the case of a website, this issue has been attempted to be addressed by several solutions, including site maps, left navigation bars, and tree structured navigation. In the case of site maps, this usually refers to a static web page that simply lists links to various sections of the website and may provide an overarching structural view of the site. The main drawback of this solution is that the page is static and the user must continuously return to this map in order to orient himself.

Left navigation bars and tree structures presented on the display may do an adequate job at defining a website or application's content, and may even refer to where in that site/application a user has visited. But these approaches typically do a poor job at 1) displaying the path a user has taken to get from one area to another and 2) displaying incongruencies as they arise, such as where a user may define a setting on one page in an application that contradicts a previously applied or not yet visited setting on a different page. Additionally, left navigation bars and tree structures take valuable room on web pages and software application interfaces that could otherwise be used to condense the page or allow for more white (blank) space for better overall ease of use.

The type of management system used in computer application programs also often times leads to the same type of errors in getting lost within the program as it is being operated as occurs when a user is navigating a complex web site. That is, a user of the program can encounter difficulty in navigating through the various sections and pages, or sub-sections, as he operates the program. Similar problems also can occur in navigating game programs.

Accordingly, a need exists for a tool presented in a simple and easy to understand format that is useful for navigating web sites and computer programs and that allows for a resolution of the above problems.

### BRIEF DESCRIPTION OF THE INVENTION

Embodiments of the invention are directed to a method and system that operates to produce an interactive “navigation box” in the form of a frame or window that displays the overall structure of a website or application. In describing the invention as applied to websites and computer programs the terms group for website pages and program section for a computer application program correspond. Similarly, a website group has pages and a program section also has pages, which would be sub-sections or modules within a program section. In accordance with the invention, in addition to showing the structure of the website or application program, the navigation box provides hyperlinks for fast access to all pages of a website or application. This permits navigation of the entire website or program from one window. The navigation box also can display the path that the user has taken to get to a certain point or page of the website or application. The navigation box also can show incongruities in settings, and. By providing the navigation box function in a frame or window, the user can move the window, enlarge it, minimize it, or close it if it proves not useful or if the user has gained adequate expertise in navigating the website or application.

According to a particular embodiment is a computer readable memory tangibly embodying a program of machine-readable instructions executable by a digital processing apparatus to perform operations directed to displaying a navigation map for an application. The operations according to this embodiment include displaying a selected page of a software application, and displaying over the selected page a navigation map. The navigation map includes a plurality of elements of the application, where one of the elements corresponds to the selected page; relationships between the plurality of elements; and a highlighted path that passes through at least one of the plurality of elements that was transited to arrive at the selected element.

According to another particular embodiment is at least one server device that includes a processor and a memory that are together configured to respond to a request from a user device for a home page. The response includes sending an applet towards the user device that provides for the display of a navigation map at the user device. The navigation map displays, simultaneously: a plurality of elements corresponding to individual ones of a set of pages that include the home page and other pages that are linked through the home page (though not necessarily only linked directly by the home page); and relationships between the plurality of elements; and also a highlighted path through each of the plurality of elements that corresponds to the pages that were displayed at the user device prior to a currently displayed page of the set of pages.

According to another particular embodiment is a method that includes receiving a request from a user device for a home page, and then responsive to the request, sending an applet towards the user device that provides for the display of a navigation map at the user device. The navigation map displays simultaneously: a plurality of elements corresponding to individual ones of a set of pages where the pages include the home page and other pages that are linked through the home page, and relationships between the plurality of elements, and a highlighted path through each of the plurality of elements that corresponds to the pages that were displayed at the user device prior to a currently displayed page of the set of pages.

### BRIEF DESCRIPTION OF THE DRAWINGS

Other objects and advantages of the present invention will become more apparent upon reference to the following specification and annexed drawings in which:

FIG. 1 is a schematic block diagram illustrating the communication between a website and a user device;

FIG. 2 is a pictorial view of a typical prior art website home page;

FIG. 3 is a pictorial view showing the navigation box of the invention on the website home page;

FIG. 3A is a view showing the details of the navigation box for a website; and

FIG. 4 is a view showing the details of the navigation box for a program that operates the resources of a computer.

FIG. 5 is a process flow diagram according to an embodiment of the invention.

### DETAILED DESCRIPTION OF THE INVENTION

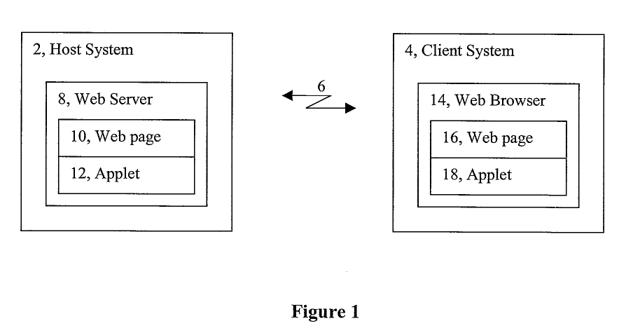

FIG. 1 is a block diagram that has a web host system 2 including a server 8. There also is a client system 4 including a web browser 14. Host system 2 and client system 4 communicate with each other in a bi-directional manner across an IP (Internet protocol) network 6 using a hyper-text transfer protocol (HTTP). IP network 6 can be, for example, the public Internet or a private intranet. The communication can be by land lines, wireless, cable satellite or any other suitable medium. Host system 2 can be one or more servers controlled by a system having a processor, a memory device and one or more storage devices such as disk drives. Client system 4 can be, for example, a personal computer, computer workstation, laptop computer, PDA or cell phone, each of which generally includes a data storage device, a memory device, a processor and a display.

The memory device in host system 2 can store program code for and the processor can execute a web server 8. A data storage device in host system 2 stores a web page 10 and an associated applet 12. The applet is written with the necessary instructions to display and manage access to the website resources. Web page 10 can be written in the hyper-text mark-up language (HTML), and applet 12 can be written in an interpretive language such as JAVA. Analogous to host system 2, the memory device in client system 4 stores code for and its processor can execute a web browser 14. The memory device in client system 4 can store a downloaded web page 16 and an associated applet 18. Web browser 14 is an applet-capable web browser and can both display web page 16 and execute applet 18. All of this is conventional.

In operation, a user of client system 4 uses the web browser 14 to transmit a request for web page 10 across IP network 6 to a host system 2. The request can be, for example, a URL (uniform resource locator) for a web page 10 that the client system user desires to view. Web server 8 receives the request from web browser 14 and, in response, packages and transmits web page 10 and applet 12 to web browser 14 across IP network 6. Web server 8 packages web page 10 and applet 12 based upon web page 10 and applet 12 stored on host system 2. These are received by the client's web browser 14 as web page 16 and applet 18. After downloading web page 16 and applet 18, web browser 14 displays web page 16 to a user of client system 4 and the browser 14 can execute applet 18. Applet 18 only needs to be downloaded once and is executed by web browser 14. When a link is selected in web page 16 by the user operating the browser 14, the browser sends web server 8 a request across IP network 6 and the web server transmits the selected page back to the user's browser.

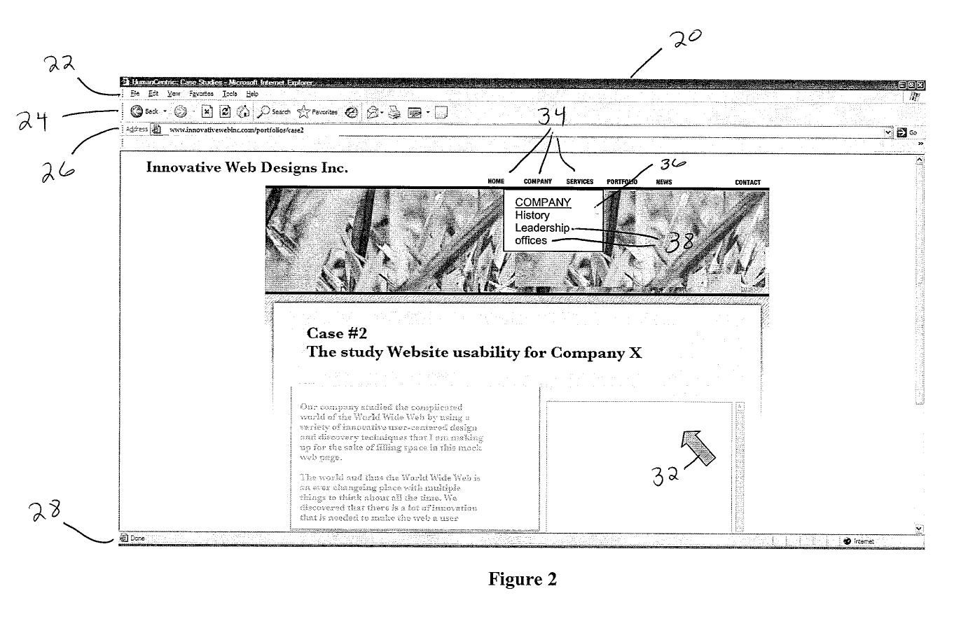

FIG. 2 shows a conventional or traditional home page of an Internet website that is displayed by a browser to a user after the user places an address, or URL, in the address box of his browser. In a preferred embodiment of the present invention, any conventional Internet browser can be used since the novel navigation box is generated from the website home page and not from or by the browser. However, it is possible to store navigation boxes of a number of websites in a central location, such as a server, and the information for a navigation box associated with a particular website be accessed when this location is addressed.

FIG. 2. shows a display window indicated generally at 20 generated by web browser 14. The window 20 can include a menu bar 22 and a plurality of buttons 24 each providing one of various functions, such as File, Edit, Tools, etc, for a user of web browser 14. Display window 20 also includes a location field 26 which serves a dual function of indicating the URL of the current location being viewed and of allowing a user to enter a new destination URL. In the illustrated example, web browser 14 is being used to navigate the public Internet, and the URL shown in location field 26 is the URL of a web page on the World Wide Web. Display window 20 further includes a status bar 28 that provides information about the operation of web browser 14. The items in menu bar 22 and buttons 24 and the general layout of display window 20 as shown in FIG. 2 are common features of browsers such as AOL-NETSCAPE NAVIGATOR, FIREFOX and others, with certain modifications between them.

Display window 20 includes a displayed web page, indicated generally at 30, which is generated by web browser 14 from the downloaded web page 16 and associated applet 18. Displayed web page 30 provides the user of web browser 14 with the information content accessed from web server 8. The user generally interacts with display window 20 and displayed web page 30 using a pointer device (e.g., a mouse or a touch pad) which controls the position of a pointer 32 and allows a user to initiate actions such as through a mouse button click or double click or pressing a touch pad.

The web page 30 also includes a plurality of hot spots 34 that provide access to embedded menus of a plurality of different groups of website pages created and managed by applet 18. Shown are hot spots 34 for the topics Home, Company, Services, Portfolio, News and Contact. These topical groups are by way of illustration only and other group topics can be used as appropriate for the website. The embedded menu for each topical group is accessed by positioning pointer 32 over one of hot spots 34. FIG. 2 shows an embedded pop up menu 36 in the displayed web page 30 which has been invoked or activated for display by positioning of pointer 32 over the Company hot spot 34. Selection of a hot spot 34 can be indicated by highlighting that hot spot with a halo or some other indication. As determined by the applet 18, the hot spot 34 is activated merely by passing the pointer 32 over it or by requiring a click of the mouse button.

Embedded menu 36 includes a banner that matches the text (“Company”) that was associated with the selected hot spot 34. The embedded menu 36 also includes a number of links 38, each providing a link to a web page, group of pages or resource. Illustratively shown under the topical group Company are the links History, Leadership and Offices. The links 38 provided by the embedded menu 36 may or may not be URLs directly accessible without initially passing through the initial displayed web home page 30.

In FIG. 2, any of the links 38 shown in the Company embedded menu 36, for example the link to “History”, can be selected by the positioning of pointer 32 over that portion of embedded menu 36 and the browser status bar 30 reflects the URL associated with the selected link. If desired, depending upon the instructions of the applet program, the web browser user can link to the “History” group information by initiating an action, for example by clicking a mouse button, while pointer 32 is in this position. The accessed link can be a single page that is downloaded from the web server and opened for view by the browser. It also can be a link that activates another embedded menu that show a sub-group of pages, such as for the History topic of the main group Company. Each of the pages of a sub-group would each have its own URL. That is, the embedded menu 36 can have multiple levels of menus accessible through initial menu options. The user can also move pointer 32 elsewhere in embedded menu 36 of the sub-groups to select and initiate one of the other links.

When the pointer 32 is moved outside of embedded menu 36, the embedded menu 36 usually will be removed, faded from the display, and the displayed web page 30 will resume its initial appearance. The user can move pointer 32 over any of hot spots 34 and invoke an associated embedded menu, each of which can provide multiple links to other web pages or resources.

As should be appreciated, as the user moves back and forth through various topical groups and the pages in the associated group menus and menus of the sub-groups, the user can become lost in that he might not recall all of the pages of the website that he has viewed, the path that he has taken and how to find his way back to a page that he desires to view again.

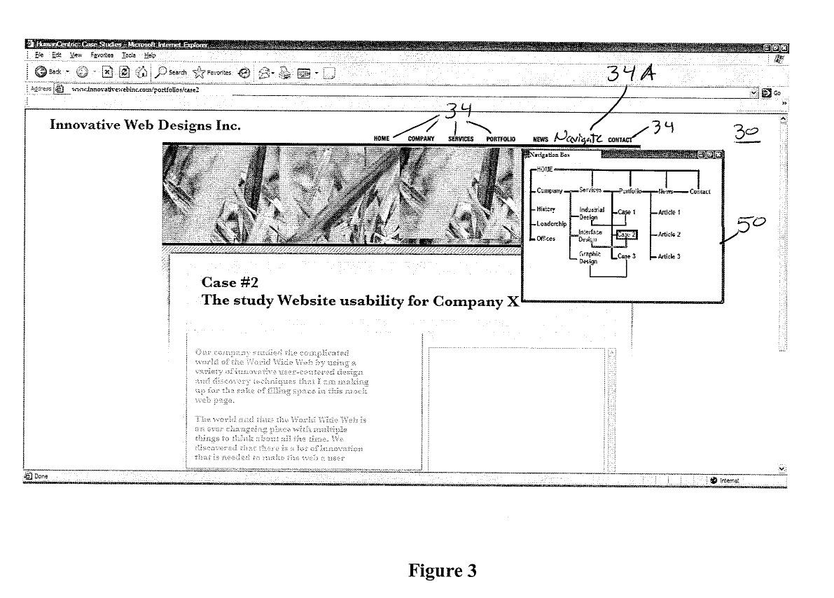

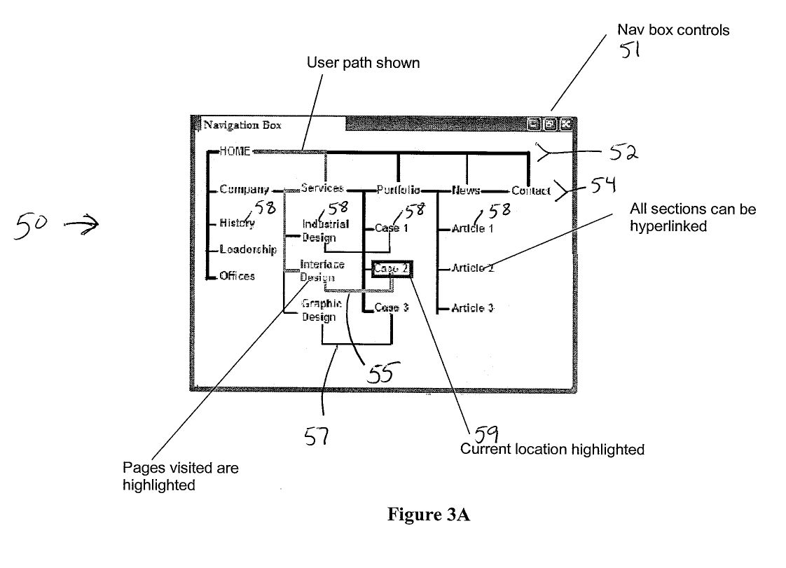

FIGS. 3 and 3A show the navigation box of the invention that makes navigation of all parts of a website easier. Referring first to FIG. 3, a URL site web home page 30 similar to that of FIG. 2 is displayed in the same manner as that described in FIG. 2 and the same reference numbers are used for the same elements and features. The web page 30 of FIG. 3 differs from that of FIG. 2 in that it has an additional hotspot 34a, designated Navigate. The applet 18 that accompanies the web page when it is called from its server by the browser is written to have not only the embedded menus 36 for each of the hot spots 34 but also an embedded active and interactive site map menu, hereafter illustratively called the navigation box 50, that is displayed as a frame or window. The navigation box 50 preferably is for all of the assets of the website that is called and displayed when the mouse pointer 32 is positioned over the Navigate hot spot 34a. The navigation box 50, which is described in detail with respect to FIG. 3A, is shown on the web page 30 as being positioned in the upper right hand corner of the web page of FIG. 3 but it can be positioned elsewhere when the Navigate hot spot 34a is activated or the box can be dragged by the mouse pointer and positioned anywhere on the web page. These functions are part of the applet.

FIG. 3A shows the details of the navigation box 50. In the upper right hand corner of the box, or in any other desired place, are the typical window controls 51 that allow the window to be minimized, expanded and the window to be closed. All of this is conventional for a windows page or frame. The navigation box 50 is illustrative shown as being applied to the topic groups of web home page 30. As seen, there is a hierarchical display of the pages of the website. The top line 52, or top order, of the hierarchy is the web home page, corresponding to the Home hot spot 34. The next lower, or second, order along horizontal line 54 are the topical groups of Company, Services, Portfolio, History and Contact, each of which corresponds to its respective hot spot on the web page. These groups are graphically shown associated with the Home top line 52 by vertical lines. Under each of the topical groups is a vertical linear embedded menu of the pages 58 in the topical groups. The pages of the embedded menu 38 of FIG. 2 for the Company are shown as well as all of the pages 58 of the other groups. For example, in the Portfolio group are the pages Case 1, Case 2, and Case 3. The number and types of pages 58 associated with each group as shown in FIG. 3A is by way only of illustration. There can be any number of groups and any number of pages in each group as would be necessary for a given website.

The applet 18 is written so that the current page being displayed by the browser preferably is highlighted, as illustrated by the box type highlight 59 of the page Case 2 of the Portfolio group. The vertical line of the group hierarchy connecting Case 2 to its group Portfolio also can be highlighted by being made bold. Moving the mouse pointer 32 over a page and clicking the mouse button will cause that page to be accessed from the web server and displayed to the user. This permits the user to access any page of the site from the within the navigation box window 50. Also, the pages that have been visited and displayed are also highlighted, preferably in a different manner than that of the box 59, such as by making a visited page stand out in bold type or a different color. In addition, the path traveled is illustrated, such as, for example, by the connecting lines 57 with the path 55 to the current page being highlighted such as in bold or being a different color. Thus, the user is presented with a view of the pages that have been visited and the path taken to visit each page.

The navigation box 50 provides a complete view of the website resources in one place. The user can easily navigate between pages of the same group. It also allows navigation between pages of different groups without having to first access the group hot spot and then accesses a page within the group as is the case with the conventional home page of FIG. 2. Further, the user is provided with a visual record of the pages that he has visited.

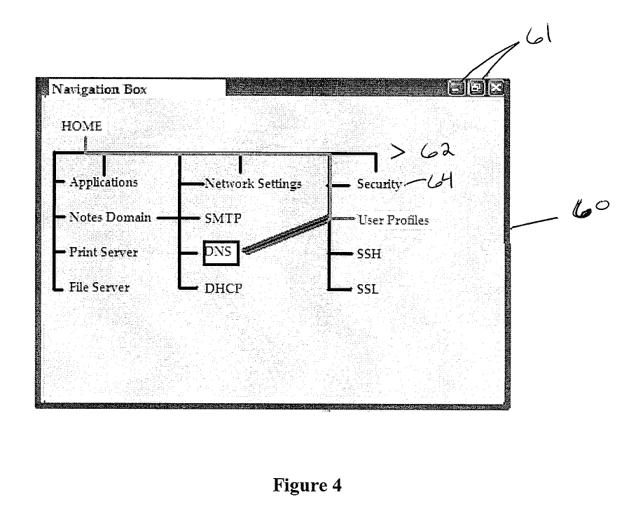

The navigation box also can be used in a computer program software application stored on a computer readable medium. Here the application program master menu would provide a display of available resources, much like a website home page. FIG. 4 shows a frame or window 60 for a computer program that corresponds to the website navigation box 50. The window 60 can be called from the program home page or can be displayed when the program is opened. The window 60 has the controls 61 in the upper right hand corner to control display size. The first order hierarchy Home line 62 has program sections 64, corresponding to the web page groups discussed above, of Applications, Network Settings and Security. A plurality of computer operation related pages or modules is part of each program section. For example, the Applications section has the pages Notes Domain, Print Server and File Server. Moving the mouse over any of the pages and clicking it will open the application page for further use. It should be noted in FIG. 4 that the DNS (Domain Name System) of the Network Settings section and the User Profiles of the Security section have incongruent settings.

The disclosed embodiments of FIGS. 3 and 4 can include mouse flyover help to provide the user with a high level description of each page shown in the navigation box. This feature could be extended such that all page descriptions are represented as nodes and when hovered over provide the page information, such as “Applications” of FIG. 4. Such a feature could reduce the space required to display the navigation box.

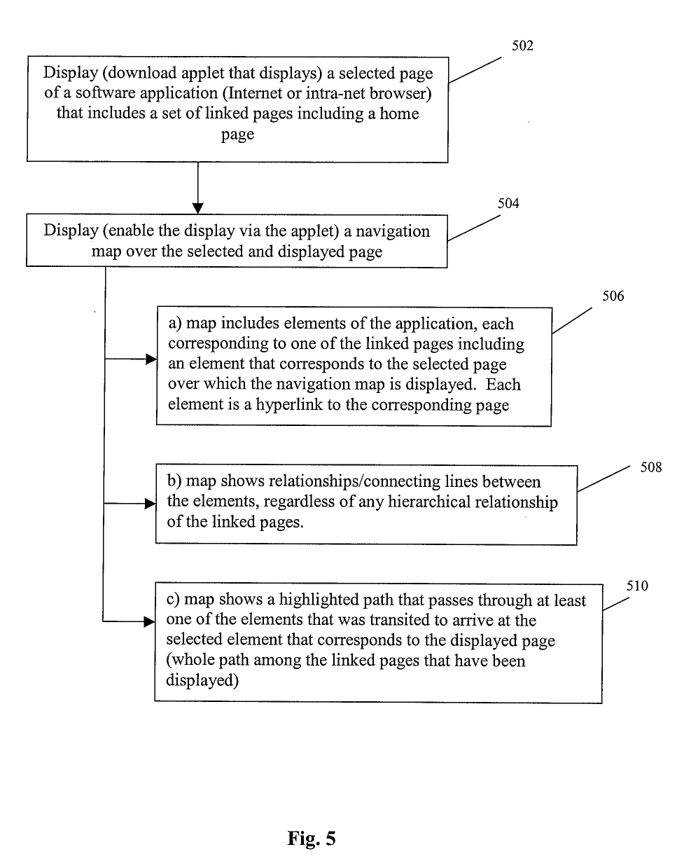

FIG. 5 shows representative process steps according to an embodiment of the invention, which may be considered to represent method steps, functions of circuitry of a hardware chip or of software or some combination thereof. Particularly it may represent the applet detailed above that is downloaded from a server of the Internet or of an intra-net in response to a request from a user device (e.g., selection of a network page such as the home page) that enables the display described at the user device. The user device may be for example as a hardwired or wireless personal computer or handheld computing device such as an internet tablet. At block 502 the software/hardware enables a selected page of a software application to be displayed. The application may include a set of linked pages such as internet-based or other browser-based pages (e.g., of an intra-net), and the set of linked pages includes a home page. At block 504 the applet enables the user device to display over the selected page a navigation map. The navigation map includes at block 506 a plurality of elements of the application such as the individual entries shown as the pages 58 in FIG. 3A, where each of the elements correspond to one of the underlying linked pages and one of the elements corresponds to the selected page over which the navigation box is displayed. The navigation box also shows at block 508 relationships between the plurality of elements, such as the connecting lines 57 of FIG. 3A. At block 510 the navigation box further shows a highlighted path such as line 55 of FIG. 3A that passes through at least one of the elements that was transited to arrive at the selected element that corresponds to the displayed page. In an embodiment the highlighted path passes through all elements which have been transited since the first page of the set of pages was displayed at the user device, and the highlighted path is cleared from the applet once the user device displays any page that is not one of the linked pages. In this manner the highlighted path shows only the user's current path, and not one traveled on a previous navigation through the linked pages such as on a previous day.

For a comprehensive navigation box, the set of elements displayed at the navigation map correspond to all of the set of linked pages regardless of whether a page is linked directly to the displayed page or indirectly through another of the set of pages, and the elements correspond to no more pages than those linked ones. Also, and regardless of the underlying linking relationship within the pages themselves, each element of the navigation map is a hyperlink to the page corresponding to that element. This is true also regardless of the relationships shown. As seen at connecting line 57 of FIG. 3A, the relationships shown on the navigation map also need not be constrained to a hierarchical linking relationship that underlies the set of linked pages; a relationship may be shown for pages that are linked to one another only through another page of the set (or through the navigation map). In an embodiment, an identical navigation map is displayed regardless of which of the linked pages is displayed underneath the navigation map. This is because the map shows the full navigation among the entire set of linked pages, so any page linked by any individual page is shown on the map for all pages. A user may shrink or expand the size of the displayed navigation map when displayed over different ones of the pages, but the identical elements and relationships are unchanged. The applet can enable a flyover help box to display when the user pauses a cursor (e.g., a graphical indicator controlled by a computer mouse) over the navigation map for a threshold amount of time without selecting one of the elements with the cursor (e.g., without depressing a mouse select button). As seen at the navigation box controls 51 of FIG. 3A, the applet can also enable the user device to display the navigation map and to remove the navigation map from being displayed in response to various user selections of those controls.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-RNV) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Specific features of the invention are shown in one or more of the drawings for convenience only, as each feature may be combined with other features in accordance with the invention. Alternative embodiments will be recognized by those skilled in the art and are intended to be included within the scope of the claims. Accordingly, the above description should be construed as illustrating and not limiting the scope of the invention. All such obvious changes and modifications are within the patented scope of the appended claims.

We claim:

1. A computer readable memory tangibly embodying a program of machine-readable instructions executable by a digital processing apparatus to perform operations directed to displaying a navigation map for an application, the operations comprising:
displaying a selected page of a software application; and
displaying over the selected page a navigation map that comprises:
a plurality of elements of the application, where the plurality of elements includes an element corresponding to the selected page,
relationships between the plurality of elements, and
a highlighted path that passes through at least one of the plurality of elements that was transited to arrive at the selected element.

2. The computer readable memory of claim 1, wherein the application comprises a set of linked pages that includes a home page, the plurality of elements displayed in the navigation map comprises links to each of the set of linked pages, and the set of linked pages comprises all pages that are linked through the home page regardless of a direct linking structure among the linked pages, where the set of linked pages comprise a set of browser based pages or a set of internet pages.

3. The computer readable memory of claim 1, wherein at least one of the relationships between two of the plurality of elements is not a hierarchical relationship.

4. The computer readable memory of claim 1, wherein the operations further comprise hyperlinking directly to each and every one of the plurality of elements displayed on the navigation map when any of the elements is selected by a user, regardless of the displayed relationships.

5. The computer readable medium of claim 4, further wherein at least a portion of the highlighted path does not follow any of the relationships displayed in the navigation map.

6. The computer readable memory of claim 1, wherein the operations display the same plurality of elements and the same relationships regardless of which of the elements is displayed as the selected page.

7. The computer readable memory of claim 1, wherein the operations further comprise displaying a flyover help block when a user pauses a cursor over the navigation map without selecting one of the elements with the cursor.

8. The computer readable memory of claim 1, wherein the operations further comprise displaying the navigation map in response to one selection by a user and removing the navigation map from being displayed in response to another user selection.

9. At least one server device comprising a processor and a memory configured to respond to a request from a user device for a home page by sending an applet towards the user device that provides for the display of a navigation map at the user device, the navigation map displaying simultaneously:
a plurality of elements corresponding to individual ones of a set of pages that include the home page and other pages that are linked through the home page;
relationships between the plurality of elements, and
a highlighted path through each of the plurality of elements that corresponds to the pages that were displayed at the user device prior to a currently displayed page of the set of pages.

10. The at least one server device of claim 9, wherein the applet provides for the display of the navigation map at the user device over a display of the home page.

11. The at least one server device of claim 9, wherein the set of linked pages comprises all pages that are linked through the home page, where the set of linked pages comprise a set of browser based pages or a set of internet pages.

12. The at least one server device of claim 9, wherein at least one of the relationships between two of the plurality of elements is not a hierarchical relationship.

13. The at least one server device of claim 9, wherein each of the plurality of elements comprises a hyperlink to its corresponding page and the applet enables selection of any of the hyperlinks regardless of the relationships that the navigation map displays.

14. The at least one server device of claim 13, further wherein the applet causes the navigation page to display the highlighted path regardless of the relationships that the navigation map displays.

15. The at least one server device of claim 9, wherein the applet causes the same plurality of elements and the same relationships to be displayed in the navigation map regardless of which of the corresponding individual ones of the set of pages are selected by the user device for display.

16. A method comprising:
receiving a request from a user device for a home page;
responsive to the request, sending an applet towards the user device that provides for the display of a navigation map at the user device, the navigation map displaying simultaneously:
a plurality of elements corresponding to individual ones of a set of pages that include the home page and other pages that are linked through the home page;
relationships between the plurality of elements, and
a highlighted path through each of the plurality of elements that corresponds to the pages that were displayed at the user device prior to a currently displayed page of the set of pages.

17. The method of claim 16, wherein the set of linked pages comprises all pages that are linked through the home page regardless of a direct linking structure among the linked pages, and wherein the set of linked pages comprises a set of browser based pages or a set of internet pages.

18. The method of claim 16, wherein at least one of the relationships between two of the plurality of elements is not a hierarchical relationship.

19. The method of claim 16, wherein each of the plurality of elements comprises a hyperlink to its corresponding page and the applet enables selection of any of the hyperlinks regardless of the relationships that the navigation map displays.

20. The method of claim 16, wherein the applet causes the same plurality of elements and the same relationships to be displayed in the navigation map regardless of which of the corresponding individual ones of the set of pages are selected by the user device for display.
